(19) United States
(12) Patent Application Publication
(10) Pub. No.: US 2009/0238412 A1
(43) Pub. Date: Sep. 24, 2009

(54) LOCAL MOTION COMPENSATED RECONSTRUCTION OF STENOSIS

(76) Inventors: Michael Grass, Buchholz In Der Nordheide (DE); Dirk Schaefer, Hamburg (DE); Babak Movassaghi, Denver, CO (US)

Correspondence Address: PHILIPS INTELLECTUAL PROPERTY & STANDARDS, P.O. BOX 3001, BRIARCLIFF MANOR, NY, 10510, US

(21) Appl. No.: 12/305,996

(22) PCT Filed: Jun. 18, 2007
(86) PCT No.: PCT/IB2007/052321

§ 371 Date: Dec. 22, 2008

(30) Foreign Application Priority Data
Jun. 28, 2006 (EP) 06116181.6

(51) Int. Cl. G06T 7/20; G06T 7/00

(52) U.S. Cl. 382/107; 382/131

(57) ABSTRACT

The analysis of a stenosis of a coronary vessel in three dimensions requires a motion compensated reconstruction. According to an exemplary embodiment of the present invention, an examination apparatus for local motion compensated reconstruction data set is provided, wherein the local motion compensated reconstruction vectors relating to a start point and an end point of the stenosis.

The invention relates to the field of tomographic imaging. In particular, the invention relates to an examination apparatus for local motion compensated reconstruction of an object of interest, to a method of local motion compensated reconstruction of an object of interest, an image processing device, a computer-readable medium, and a program element.

Currently, two dimensional angiograms of the coronary vessels are mainly used for the analysis and quantification of stenosis. The analysis in three dimensions requires, in case of moving structures as for example the heart, the application of motion compensated reconstruction techniques. Usually, such motion compensated reconstruction is performed for the whole data set. This may require a lot of computational effort and may therefore consume a significant amount of calculation time.

It would be desirable to have an improved motion compensated three-dimensional stenosis reconstruction from projection data.

The invention provides an examination apparatus, an image processing device, a method of local compensated reconstruction of an object of interest on the basis of a projected data set, a computer-readable medium and a program element with the features according to the independent claims.

It should be noted that the following described exemplary embodiments of the invention apply also for the method, the computer-readable medium, the image processing device and for the program element.

According to an exemplary embodiment of the present invention, an examination apparatus for local motion compensated reconstruction of an object of interest on the basis of a projection data set may be provided, the examination apparatus comprising a reconstruction unit adapted for determining, for a projection of the projection data set, a start point and an end point of a region of the object of interest, determining a first motion vector on the basis of the start point and a second motion vector on the basis of the end point, and performing a motion compensated reconstruction of the region of the object of interest on the basis of the first and second motion vectors, wherein the determination of the start point and the end point of the region of the object of interest is performed on the basis of an evaluation of a distance function relating to the object of interest.

Therefore, the examination apparatus may be adapted for performing a local motion compensated reconstruction of a stenosis on the basis of motion vectors relating to start and end points of the stenosis. Furthermore, the motion compensated reconstruction may only be performed for the particular (identified) region and not for the whole image. The region is thereby identified on the basis of its starting and end points. It should be noted, however, that further means of identification of the particular region may be adapted.

It should be noted, that all motion vectors relate to a reference state. For example, projections are selected which correspond to different projection angles in the reference state. Then, the start and end points of the stenosis are determined in the reference state projections. After that, a three-dimensional calculation of the reference start and end points (eventually together with a calculation of an average (reference) distance function between these points) is performed. Then, a forward projection of the start point, the end point and the reference distance function on all projections is performed and the motion vectors for the projection are determined.

According to another exemplary embodiment of the present invention, the examination apparatus further comprises a detector unit adapted for acquisition of the projection data set along a single rotation of a gantry and an electrocardiogram unit adapted for acquisition of electrocardiogram data along the single rotation of the gantry.

Therefore, according to this exemplary embodiment of the invention, both projection data and electrocardiogram data are acquired during only one gantry rotation. The electrocardiogram data may then, together with the projection data, be used for motion compensated reconstruction.

According to another exemplary embodiment of the present invention, the examination apparatus is further adapted for determining a centreline of the object of interest and determining, at a first distance from a reference point of the object of interest, a first radius of the object of interest perpendicular to the centreline, and determining, at a second distance from the reference point of the object of interest, a second radius of the object of interest perpendicular to the centreline, resulting in a radius value as a function of the distance The determination of the start point and the end point of the region of the object of interest is performed on the basis of an evaluation of the distance function.

Therefore, the distance function represents the radius of the coronary artery perpendicular to the centreline direction and may be stored as a function of the distance from the root of the coronary tree.

According to another exemplary embodiment of the present invention, the determination of the centreline is performed on the basis of one of a gradient driven two-dimensional spline adaption and a multi-scale filter.

According to another exemplary embodiment of the present invention, the evaluation of the function comprises at least one of a determination of a minimum of a first derivative of the distance function, a determination of a maximum of the first derivative of the distance function, and a determination of a zero point of a second derivative of the distance function.

This may provide for a fast and effective determination of the start and end points.

According to another exemplary embodiment of the present invention, the object of interest is a coronary artery, and the region of the object of interest is a stenosis of the coronary artery.

Therefore, according to this exemplary embodiment of the present invention, a non-interactive motion compensated stenosis reconstruction from projection data may be provided.

According to another exemplary embodiment of the present invention, the examination apparatus is adapted as one of a three-dimensional rotational x-ray apparatus and a three-dimensional computed tomography apparatus.

It should be noted in this context, that the present invention is not limited to computed tomography, but may always then be applied when a local motion compensated reconstruction of a region of an object of interest has to be performed and the region (i.e. the stenosis of an artery) is visible in the image.

According to another exemplary embodiment of the present invention, the examination apparatus is configured as one of the group consisting of a 3D rotational X-ray apparatus, a medical application apparatus and a micro CT system. A field of application of the invention may be medical imaging, in particular interventional cardiac X-ray imaging/coronary angiography.

According to another exemplary embodiment of the present invention, the motion compensated reconstruction of the region of the object of interest is a non-interactive three-dimensional stenosis reconstruction.

Furthermore, the examination apparatus may be adapted for performing a scaling operation of the region of the object of interest on the basis of a change of the distance function along the centreline.

It should be noted, that the determination of the distance function (i.e. the radius as a function of the distance) may be performed on the basis of the average (reference) distance function (which is determined from reference data). For doing this, the average distance function is determined as described above and projected on each projection. Furthermore, translation, rotation or scaling operations or any other suitable transformation may be performed, such that both functions are mapped to each other, thereby allowing for a movement of selected points or even for all points of the average distance function.

According to another exemplary embodiment of the present invention, the transformation of the centreline in each projection onto the forward projected reference centreline is performed on the basis of a curvature of the centreline, a grey value function in the neighbourhood of the centreline or any other function carrying information connected to the vessel piece, which is represented by the centreline.

This may provide for an improved image quality.

According to another exemplary embodiment of the present invention, a method of motion compensated reconstruction of an object of interest on the basis of a projection data set may be provided, the method comprising the steps of determining, for a projection of the projection data set, a start point and an end point of a region of the object of interest, determining a first motion vector on the basis of the start point, the second motion vector on the basis of the end point, and performing a motion compensated reconstruction of the region of the object of interest on the basis of the first and second motion vectors, wherein the determination of the start point and the end point of the region of the object of interest is performed on the basis of an evaluation of a distance function relating to the object of interest.

This may provide for a fast and effective motion compensated reconstruction of stenosis.

According to another exemplary embodiment of the present invention, an image processing device for local motion compensated reconstruction may be provided, comprising a memory for storing a data set of the object of interest and a reconstruction unit adapted for carrying out the above-mentioned method steps.

Such a reconstruction may be based on a reconstruction as described in D. Schafer, A. Engler, J. Borgert, and M. Grass ‘Motion compensated cone beam filtered back-projection for 3D rotational X-ray angiography: A simulation study’, Proceedings of the 8^{th} International Meeting on Fully Three-Dimensional Image Reconstruction, Salt Lake City, USA 2005, pp. 360-363, which is hereby incorporated by reference.

According to another exemplary embodiment of the present invention, a computer-readable medium may be provided, in which a computer program of local motion compensated reconstruction is stored which, when being executed by a processor, is adapted to carry out the above-mentioned method steps.

Beyond this, according to another exemplary embodiment of the present invention, a program element of local motion compensated reconstruction of an object of interest on the basis of a projection data set may be provided, which, when being executed by a processor, is adapted to carry out the above-mentioned method steps.

The examination of the object of interest may be realised by the computer program, i.e. by software, or by using one or more special electronic optimisation circuits, i.e. in hardware, or in hybrid form, i.e. by means of software components and hardware components.

The program element according to an exemplary embodiment of the present invention may preferably be loaded into working memories of a data processor. The data processor may thus be equipped to carry out exemplary embodiments of the methods of the present invention. The computer program may be written in a suitable programming language such as, for example, C++ and may be stored on a computer-readable medium, such as a CD-ROM. Also, the computer program may be available from a network, such as the World Wide Web, from which it may be downloaded into image processing units or processors, or any suitable computers.

It may be seen as the gist of an exemplary embodiment of the present invention that the shape of a coronary artery of interest is analysed, and a region is identified which comprises a stenosis. Then, a local motion compensated reconstruction of the stenosis is performed on the basis of motion vectors relating to start and end points of the stenosis.

These and other aspects of the present invention will become apparent from and elucidated with reference to the embodiments described hereinafter.

Exemplary embodiments of the present invention will be described in the following, with reference to the following drawings.

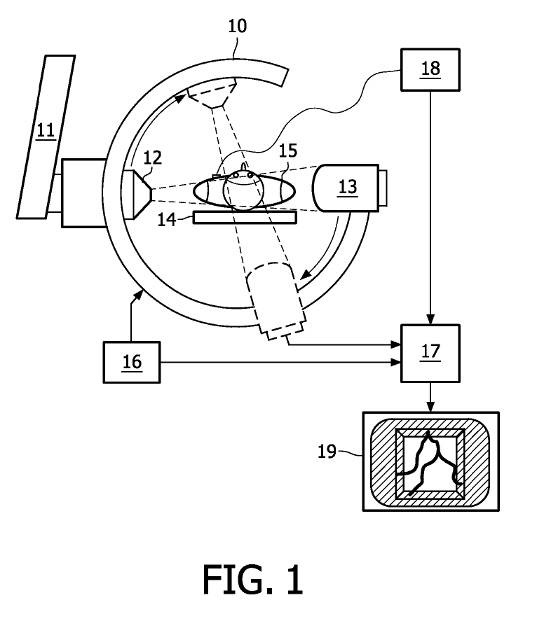

FIG. 1 shows a simplified schematic representation of an examination apparatus according to an exemplary embodiment of the present invention.

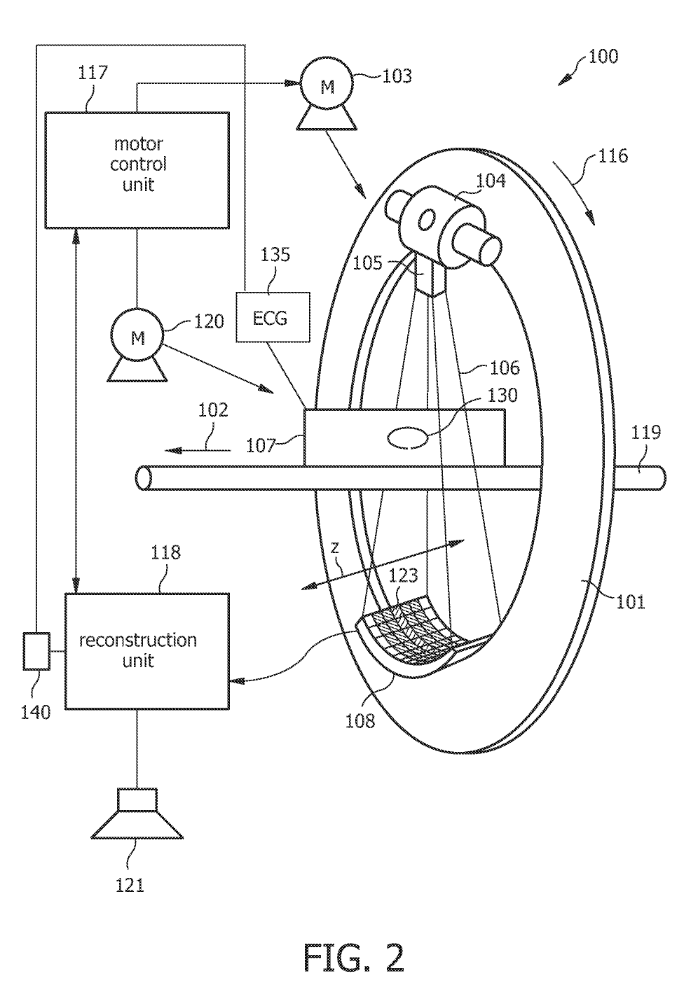

FIG. 2 shows a schematic representation of an examination apparatus according to another exemplary embodiment of the present invention.

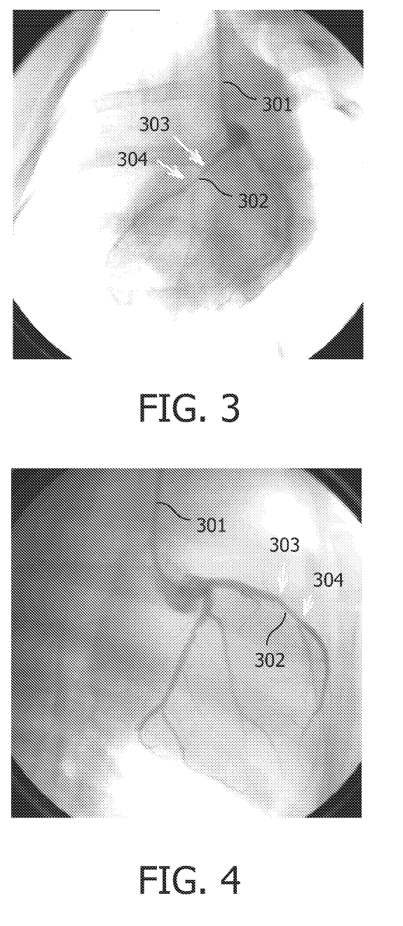

FIG. 3 shows a schematic representation of a first projection of a rotational run acquired for three-dimensional rotational coronary angiography.

FIG. 4 shows a schematic representation of a second projection of a rotational run acquired for a three-dimensional rotational coronary angiography.

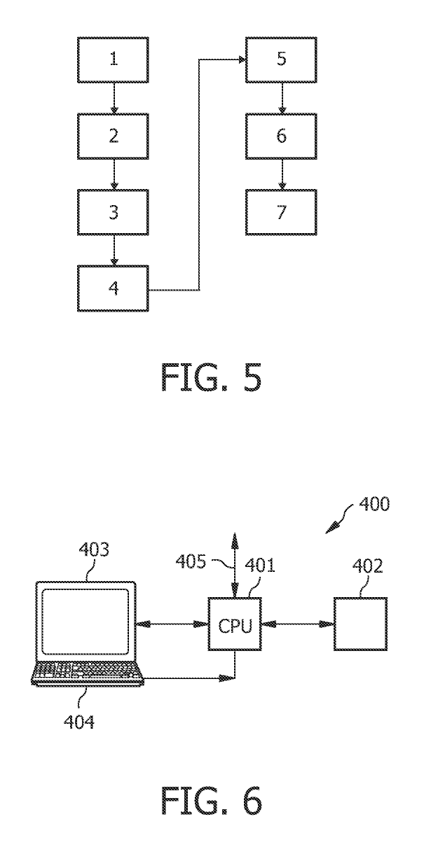

FIG. 5 shows a flow-chart of an exemplary method according to the present invention.

FIG. 6 shows an exemplary embodiment of an image processing device according to the present invention, for executing an exemplary embodiment of the method in accordance with the present invention.

The illustration in the drawings is schematic. In different drawings, similar or identical elements are provided with the same reference numerals.

FIG. 1 shows a simplified schematic representation of an examination apparatus according to an exemplary embodiment of the present invention.

The invention may be applied in the field of three-dimensional rotational x-ray imaging or three-dimensional rotational angiography imaging. In such a case, the examination may be performed with conventional x-ray systems.

The invention may be particularly used when a stenosis of a coronary artery has to be identified and a motion compensated reconstruction has to be performed locally.

The apparatus depicted in FIG. 1 is a C-arm x-ray examination apparatus, comprising a C-arm 10 attached to a ceiling (not depicted in FIG. 1) by means of an attachment 11. C-arm 10 holds the x-ray source 12 and detector unit 13, which may be rotatedly mounted to the C-arm 10, such that a plurality of projection images of a patient 15 on table 14 can be acquired under different angles of projection.

The control unit 16 is adapted for controlling a synchronised movement of the source 12 and the detector 13, which both rotate around the patient 15.

The image data generated by the detector unit 13 is transmitted to image processing unit 17 which is controlled by a computer.

Furthermore, an electrocardiogram (ECG) unit 18 may be provided for recording the heartbeat of the patient's heart. The corresponding ECG data is then transmitted to the image processing unit 17.

The image processing unit 17 is adapted to carry out the above-mentioned method steps.

Furthermore, the system may comprise a monitor 19 adapted for visualising the acquired images.

However, the invention may also be applied in the field of computed tomography.

FIG. 2 shows an exemplary embodiment of a computed tomography scanner system according to the present invention.

The computer tomography apparatus 100 depicted in FIG. 2 is a cone-beam CT scanner. However, the invention may also be carried out with a fan-beam geometry. In order to generate a primary fan-beam, the aperture system 105 can be configured as a slit collimator. The CT scanner depicted in FIG. 2 comprises a gantry 101, which is rotatable around a rotational axis 102. The gantry 101 is driven by means of a motor 103. Reference numeral 104 designates a source of radiation such as an X-ray source, which, according to an aspect of the present invention, emits polychromatic or monochromatic radiation.

Reference numeral 105 designates an aperture system which forms the radiation beam emitted from the radiation source to a cone-shaped radiation beam 106. The cone-beam 106 is directed such that it penetrates an object of interest 107 arranged in the center of the gantry 101, i.e. in an examination region of the CT scanner, and impinges onto the detector 108. As may be taken from FIG. 2, the detector 108 is arranged on the gantry 101 opposite to the source of radiation 104, such that the surface of the detector 108 is covered by the cone beam 106. The detector 108 depicted in FIG. 2 comprises a plurality of detector elements 123 each capable of detecting X-rays which have been scattered by or passed through the object of interest 107.

During scanning the object of interest 107, the source of radiation 104, the aperture system 105 and the detector 108 are rotated along the gantry 101 in the direction indicated by an arrow 116. For rotation of the gantry 101 with the source of radiation 104, the aperture system 105 and the detector 108, the motor 103 is connected to a motor control unit 117, which is connected to a reconstruction unit 118 (which might also be denoted as a calculation or determination unit).

In FIG. 2, the object of interest 107 is a human being which is disposed on an operation table 119. During the scan of, e.g., the heart 130 of the human being 107, while the gantry 101 rotates around the human being 107. By this, the heart 130 is scanned along a circular scan path.

Moreover, an electrocardiogram device 135 may be provided which measures an electrocardiogram of the heart 130 of the human being 107 while X-rays attenuated by passing the heart 130 are detected by detector 108. The data related to the measured electrocardiogram are transmitted to the reconstruction unit 118.

The detector 108 is connected to the control unit 118. The reconstruction unit 118 receives the detection result, i.e. the read-outs from the detector elements 123 of the detector 108 and determines a scanning result on the basis of these read-outs. Furthermore, the reconstruction unit 118 communicates with the motor control unit 117 in order to coordinate the movement of the gantry 101 with motors 103 and 120.

The reconstruction unit 118 may be adapted for reconstructing an image from read-outs of the detector 108. A reconstructed image generated by the reconstruction unit 118 may be output to a display (not shown in FIG. 2) via an interface 122.

The reconstruction unit 118 may be realized by a data processor to process read-outs from the detector elements 123 of the detector 108.

The computer tomography apparatus shown in FIG. 2 captures cardiac computer tomography data of the heart 130. In other words, when the gantry 101 rotates a circular scan is performed by the X-ray source 104 and the detector 108 with respect to the heart 130. During this circular scan, the heart 130 may beat a plurality of times. During these beats, a plurality of cardiac computer tomography data are acquired. Simultaneously, an electrocardiogram may be measured by the electrocardiogram unit 135. After having acquired these data, the data are transferred to the reconstruction unit 118, and the measured data may be analyzed retrospectively.

The measured data, namely the cardiac computer tomography data and the electrocardiogram data are processed by the reconstruction unit 118 which may be further controlled via a graphical user-interface (GUI) 140. This retrospective analysis is based on a cardiac cone beam reconstruction scheme using retrospective ECG gating. It should be noted, however, that the present invention is not limited to this specific data acquisition and reconstruction.

FIG. 3 shows a schematic representation of a first projection of a rotational run acquired for a three-dimensional rotational coronary angiography. As may be seen from FIG. 3, the coronary artery 301 comprises a stenosis 302 having a start point 303 and an end point 304.

FIG. 4 shows a second projection of the rotational run acquired for three-dimensional rotational coronary angiography. Again, the start and end points 303, 304 of the coronary artery 301 are clearly visible.

As already mentioned above, for motion compensated stenosis reconstruction, a local high resolution motion compensated reconstruction of a volume of interest (stenosis) is sufficient. Therefore, a non-interactive method for motion compensated three-dimensional stenosis reconstruction from projection data is provided, according to an exemplary embodiment of the present invention.

FIG. 5 shows a flow-chart of an exemplary method according to the present invention. The method starts at Step 1, in which a beam, such as an x-ray beam, is emitted from a radiation source towards the object of interest.

Then, in Step 2, projection data of the coronary artery tree is acquired along a single rotational run while electrocardiogram data is recorded in parallel.

Then, in Step 3, the centreline of the coronary artery of interest is determined in the two-dimensional angiograms, e.g. by using an appropriate multi-scale filter or by gradient driven two-dimensional spline adaption, or any other vesselness filter.

In the following Step 4, the radius of the coronary artery is determined perpendicular to the centreline direction and stored as a function of the distance from the route of the coronary tree. For example, a calculation of a gradient or a fitting of a Gaussian profile with variable width may be used for the determination of the radius. Stenosis show up in this function as a strong decrease of the radius followed by an increase at a greater distance. In between, the radius as a function of the distance has a characteristic shape. The starting and the end point of the stenosis can be detected as the minimum and maximum (zero points) of the first (second) derivative of the radius along the centreline. For a number of projections from the rotational run, e.g. those in which no dominant anatomic structure is overlapping and those where the projection direction is not equal to the direction of the centreline, these points may be extracted from the projections, as depicted in FIG. 3.

Then, in Step 5, the start and the end points are used to determine the motion vectors for every projection where the stenosis is visible.

Moreover, an interpolation of the motion vector field is may be performed after determining the motion vector of the start point and the motion vector of the end point. The interpolation may be a three-dimensional interpolation of the motion vectors, such as a tri-linear interpolation, or may be performed on the basis of the transformation of the centreline. The interpolation results in a determination of a respective motion vector for each voxel of the region of interest. This may provide for an improved accuracy of the motion compensation.

Furthermore, those motion vectors are used in a subsequent motion compensated reconstruction process in Step 6. This motion reconstruction process may be equivalent to the procedure which is applied in three-dimensional stent boosting.

In addition to the start and the end points only, the characteristic radial change along the stenosis represents the scaling of the stenosis as a consequence of coronary movement. Such a scaling may be performed in Step 7.

FIG. 7 depicts an exemplary embodiment of a data processing device 400 according to the present invention for executing an exemplary embodiment of a method in accordance with the present invention. The data processing device 400 depicted in FIG. 7 comprises a central processing unit (CPU) or image processor 401 connected to a memory 402 for storing an image depicting an object of interest, such as a patient or an item of baggage. The data processor 401 may be connected to a plurality of input/output network or diagnosis devices, such as a CT device. The data processor 401 may furthermore be connected to a display device 403, for example, a computer monitor, for displaying information or an image computed or adapted in the data processor 401. An operator or user may interact with the data processor 401 via a keyboard 404 and/or other output devices, which are not depicted in FIG. 7.

Furthermore, via the bus system 405, it may also be possible to connect the image processing and control processor 401 to, for example, a motion monitor, which monitors a motion of the object of interest. In case, for example, a lung of a patient is imaged, the motion sensor may be an exhalation sensor. In case the heart is imaged, the motion sensor may be an electrocardiogram.

Exemplary embodiments of the invention may be sold as a software option to CT scanner console, imaging workstations or PACS workstations.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Examination apparatus (100) for local motion compensated reconstruction of an object of interest (107) on the basis of a projection data set, the examination apparatus (100) comprising:
a reconstruction unit (118) adapted for:
determining, for a projection of the projection data set, a start point (201) and an end point (202) of a region (203) of the object of interest (107);
determining a first motion vector on the basis of the start point and a second motion vector on the basis of the end point;
performing a motion compensated reconstruction of the region (203) of the object of interest (107) on the basis of the first and second motion vectors;
wherein the determination of the start point (201) and the end point (202) of the region (203) of the object of interest (107) is performed on the basis of an evaluation of a distance function relating to the object of interest (107).

2. The examination apparatus (100) of claim 1, further comprising:
a detector unit (108) adapted for acquisition of the projection data set along a single rotation of a gantry; and
an electrocardiogram unit adapted for acquisition of electrocardiogram data along the single rotation of the gantry.

3. The examination apparatus (100) of claim 1, further adapted for:
determining a centreline (204) of the object of interest (107);
determining, at a first distance from a reference point of the object of interest (107), a first radius of the object of interest (107) perpendicular to the centreline, and determining, at a second distance from the reference point of the object of interest (107), a second radius of the object of interest (107) perpendicular to the centreline, resulting in the distance function in form of a radius value as a function of the distance;
wherein the determination of the start point (201) and the end point (202) of the region (203) of the object of interest (107) is performed on the basis of an evaluation of the distance function.

4. The examination apparatus (100) of claim 3,
wherein the determination of the centreline is performed on the basis of one of a gradient driven two-dimensional spline adaption and a multi-scale filter.

5. The examination apparatus (100) of claim 3,
wherein the evaluation of the distance function comprises at least one of a determination of a minimum of a first derivative of the distance function, a determination of a maximum of the first derivative of the distance function, and a determination of a zero point of a second derivative of the distance function.

6. The examination apparatus (100) of claim 1,
wherein the object of interest (107) is a coronary artery; and
wherein the region (203) of the object of interest (107) is a stenosis of the coronary artery.

7. The examination apparatus (100) of claim 1, configured as one of a three-dimensional rotational X-ray apparatus and a three-dimensional computed tomography apparatus.

8. The examination apparatus (100) of claim 1, configured as one of the group consisting of a medical application apparatus and a micro CT system.

9. The examination apparatus (100) of claim 1, wherein the motion compensated reconstruction of the region (203) of the object of interest (107) is a non-interactive three-dimensional stenosis reconstruction.

10. The examination apparatus (100) of claim 1, further adapted for:
performing a scaling operation of the region (203) of the object of interest (107) on the basis of a change of the distance function along the centreline.

11. The examination apparatus (100) of claim 1,
wherein a determination of a centreline onto the forward projected reference centreline is performed on the basis of a curvature of the distance function, a gray value function or any other function of the projection data set.

12. Method of local motion compensated reconstruction of an object of interest on the basis of a projection data set, the method comprising the steps of:
determining, for a projection of the projection data set, a start point (201) and an end point (202) of a region (203) of the object of interest (107);
determining a first motion vector on the basis of the start point and a second motion vector on the basis of the end point;
performing a motion compensated reconstruction of the region (203) of the object of interest (107) on the basis of the first and second motion vectors;
wherein the determination of the start point (201) and the end point (202) of the region (203) of the object of interest (107) is performed on the basis of an evaluation of a distance function relating to the object of interest (107).

13. An image processing device for local motion compensated reconstruction of an object of interest on the basis of a projection data set, the image processing device comprising:
a memory for storing a data set data of the object of interest (107);
a reconstruction unit (118) adapted for:
determining, for a projection of the projection data set, a start point (201) and an end point (202) of a region (203) of the object of interest (107);
determining a first motion vector on the basis of the start point and a second motion vector on the basis of the end point;
performing a motion compensated reconstruction of the region (203) of the object of interest (107) on the basis of the first and second motion vectors;
wherein the determination of the start point (201) and the end point (202) of the region (203) of the object of interest (107) is performed on the basis of an evaluation of a distance function relating to the object of interest (107).

14. A computer-readable medium (402), in which a computer program of local motion compensated reconstruction of an object of interest on the basis of a projection data set is stored which, when being executed by a processor (401), is adapted to carry out the steps of:
determining, for a projection of the projection data set, a start point (201) and an end point (202) of a region (203) of the object of interest (107);
determining a first motion vector on the basis of the start point and a second motion vector on the basis of the end point;
performing a motion compensated reconstruction of the region (203) of the object of interest (107) on the basis of the first and second motion vectors;
wherein the determination of the start point (201) and the end point (202) of the region (203) of the object of interest (107) is performed on the basis of an evaluation of a distance function relating to the object of interest (107).

15. A program element of local motion compensated reconstruction of an object of interest on the basis of a projection data set, which, when being executed by a processor (401), is adapted to carry out the steps of:
determining, for a projection of the projection data set, a start point (201) and an end point (202) of a region (203) of the object of interest (107);
determining a first motion vector on the basis of the start point and a second motion vector on the basis of the end point;
performing a motion compensated reconstruction of the region (203) of the object of interest (107) on the basis of the first and second motion vectors;
wherein the determination of the start point (201) and the end point (202) of the region (203) of the object of interest (107) is performed on the basis of an evaluation of a distance function relating to the object of interest (107).
